(19) United States
(12) Patent Application Publication
(10) Pub. No.: US 2026/0174061 A1
(43) Pub. Date: Jun. 25, 2026

(54) Indoor Cat Exerciser (Feline Fun Track)

(71) Applicant: IlaMarie Wolusky, St Johnsbury, VT (US)

(72) Inventor: IlaMarie Wolusky, St Johnsbury, VT (US)

(21) Appl. No.: 19/541,248

(22) Filed: Feb. 16, 2026

Related U.S. Application Data
(63) Continuation-in-part of application No. 19/402,813, filed on Nov. 26, 2025.
(60) Provisional application No. 63/725,426, filed on Nov. 26, 2024.

(51) Int. Cl. A01K 15/02; A01K 1/01; A01K 15/04

(52) U.S. Cl. CPC A01K 15/025; A01K 1/0107; A01K 1/0114; A01K 15/024; A01K 15/026; A01K 15/04

(57) ABSTRACT

The indoor cat exerciser is an innovative exercise system for indoor cats that combines interactive play with treat dispensing and auditory stimuli. The system includes a track for a toy, adjustable speeds, and the ability to customize the layout with various track sections and add-ons. It supports the natural hunting instincts of cats and can be mounted on walls to save space. Key features include self-starting, stopping and random movement patterns in a sensory-rich environments with real or artificial grass, carpeted shelves for claws and audio clips.

### FIELD OF THE INVENTION

The present invention relates generally to exercise toys for pets. Particularly, the present invention is an indoor exerciser system providing a stimulating and engaging experience for cats.

### BACKGROUND OF THE INVENTION

This system allows cats to exercise their natural instincts while remaining indoors, promoting physical and mental well-being, particularly when owners are not at home.

### SUMMARY OF THE INVENTION

The indoor cat exerciser is an innovative exercise system for indoor cats that combines interactive play with treat dispensing and auditory stimuli. The system includes a track for a toy, adjustable speeds, and the ability to customize the layout with various track sections and add-ons. It supports the natural hunting instincts of cats and can be mounted on walls to save space. Key features include self-starting, stopping and random movement patterns in a sensory-rich environments with real or artificial grass, carpeted shelves for claws and audio clips.

### BRIEF DESCRIPTION OF THE DRAWINGS

FIG. 1 is an illustration of the present invention.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header. All illustrations of the drawings are for the purpose of describing selected versions of the present invention and are not intended to limit the scope of the present invention. The present disclosure includes many aspects and features. Moreover, while many aspects and features relate to, and are described in the context of the disclosed use cases, embodiments of the present disclosure are not limited to use only in this context.

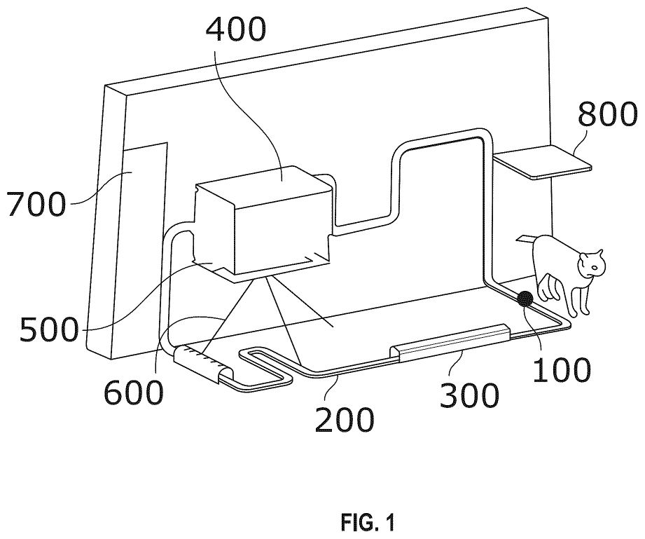

As shown in FIG. 1, the present invention is a indoor cat exerciser system comprising a plurality of toys 100, a track 200, a plurality of tunnels 300, 400, a plurality of cat grass trays 500, a laser 600, a carpet section 700, and a carpeted shelf 800.

Said plurality of toys 100 move along said track 200 with random patterns, mimicking natural prey movements. With interaction from a user, said plurality of toys 100 move forward, backward, or in changing directions before dispensing a treat. When a toy 100 detects a tunnel of said plurality of tunnels, the toy 100 will play prerecorded audio, including scratching, digging, or squeaking sounds, to keep a user's attention and interest. In the preferred embodiment of the present invention, a toy of said plurality of toys 100 further comprises of an audio mechanism to play said prerecorded audio.

Throughout several embodiments, said track 200 extends along baseboards and walls to create a dynamic, space-saving pathway for said plurality of toys 100. Additional track sections such as vertical and horizontal corners allow said track 200 to change directions including up or down a wall. In the preferred embodiment of the present invention, said track 200 has a modular design enabling customization to fit various home layouts.

Said plurality of tunnels further comprise a small tunnel 300 and a stalking tunnel 400. Said small tunnel 300 is placed over said track 200. When a toy of said plurality of toys 100 enters said small tunnel 300, the toy 100 stops and plays prerecorded audio to keep a user's attention and interest. In response to the audio, the user will try to reach through the holes in said small tunnel 300 trying to get to the toy 100. Said stalking tunnel 400 is placed over said track 200. Within said stalking tunnel 400, real or artificial cat grass hangs from the top of said stalking tunnel 400, allowing a user to stalk a toy 100.

Said plurality of cat grass trays 500 are replaceable trays placed along said track 200 within said stalking tunnel 400. In some embodiments, said plurality of cat grass trays 500 are trays of real cat grass grown. In some embodiments, said plurality of cat grass trays 500 are trays of artificial cat grass safe for chewing. In the preferred embodiment of the present invention, the cat grass trays 500 are a healthy snack that supports the digestion and natural behavior of cats.

Said laser 600 generates random projections onto nearby floors or walls. Said laser 600 further engages the user by providing unpredictable visual stimuli, encouraging active play and exploration. Said laser 600 turns on with user interaction and off with no interaction to save energy.

Said carpet section 700 is integrated along the sides of said track 200 in a vertical track position. Said carpet section 700 provides platforms for the user to climb or jump onto while in vertical pursuit of a toy 100.

Said carpeted shelf 800 is mounted on the wall near said track 200, providing a way for the user to climb and jump onto enhancing the vertical dimension of play.

The present invention provides various unique benefits. The present invention mimics a cat's natural hunting environment for mental and physical stimulation. The present invention incorporates random movements which is important as cats quickly tire of toys that move in a predictable manner or do not move on their own. The present invention incorporates interactive accessories with options of different toys 100 such as chipmunks, lizards, or snakes that hold and release treats when stepped on. These accessories start, stop, go, change direction, and shut down on their own to save energy. Real and long cat grass seed trays or artificial non-toxic cat grass trays 500 hang upside down in said stalking tunnel 400 so the cat can “stalk” its prey and obtain a treat, exercising a natural instinct for a cat. A plurality of tracks 200 can be put together in any design while saving space due to the vertical design. Carpet strips and shelves can be placed or substituted to suit design needs. The present invention includes a small tunnel for toys 100 to “hide” in. Toys 100 sense and stop within the tunnel. The tunnel or the toy 100 plays audio of critters scratching and making noise. The tunnel further includes holes for cats to put their paws through to try to get toys 100.

Although the invention has been explained in relation to its preferred embodiment, it is to be understood that many other possible modifications and variations can be made without departing from the spirit and scope of the invention.

What is claimed is:

1. An indoor cat exerciser system, comprising:
a plurality of toys,
a track, and
at least one tunnel.

2. The indoor cat exerciser system of claim 1, further comprising:
a plurality of cat grass trays,

3. The indoor cat exerciser system of claim 1, further comprising:
a laser.

4. The indoor cat exerciser system of claim 1, further comprising:
a carpet section.

5. The indoor cat exerciser system of claim 1, further comprising:
a carpeted shelf.

6. The indoor cat exerciser system of claim 1,
wherein said at least one tunnel further comprises a small tunnel.

7. The indoor cat exerciser system of claim 1,
wherein said at least tunnel further comprises a stalking tunnel.

8. The indoor cat exerciser system of claim 1,
wherein a toy of said plurality of toys further comprises an audio mechanism.

9. An indoor cat exerciser system, comprising:
a plurality of toys,
a track,
at least one tunnel; and
a plurality of cat grass trays.

10. The indoor cat exerciser system of claim 9, further comprising:
a laser.

11. The indoor cat exerciser system of claim 9, further comprising:
a carpet section.

12. The indoor cat exerciser system of claim 9, further comprising:
a carpeted shelf.

13. The indoor cat exerciser system of claim 9,
wherein said at least one tunnel further comprises a small tunnel.

14. The indoor cat exerciser system of claim 9,
wherein said at least tunnel further comprises a stalking tunnel.

15. The indoor cat exerciser system of claim 9,
wherein a toy of said plurality of toys further comprises an audio mechanism.

16. An indoor cat exerciser system, comprising:
a plurality of toys,
an audio mechanism;
a track,
at least one tunnel;
a plurality of cat grass trays; and
a laser.

17. The indoor cat exerciser system of claim 16, further comprising:
a carpet section.

18. The indoor cat exerciser system of claim 16, further comprising:
a carpeted shelf.

19. The indoor cat exerciser system of claim 16,
wherein said at least one tunnel further comprises a small tunnel.

20. The indoor cat exerciser system of claim 16,
wherein said at least tunnel further comprises a stalking tunnel.
